(19) United States
(12) Patent Application Publication
(10) Pub. No.: US 2014/0105682 A1
(43) Pub. Date: Apr. 17, 2014

(54) ENGAGING FIXING MODULE

(71) Applicant: QISDA Corporation, Taoyuan (TW)

(72) Inventor: Sheng-Chi Chen, New Taipei City (TW)

(73) Assignee: QISDA Corporation, Taoyuan (TW)

(21) Appl. No.: 14/054,819

(22) Filed: Oct. 15, 2013

(30) Foreign Application Priority Data
Oct. 17, 2012 (TW) 101138272

(51) Int. Cl. F16B 1/00

(52) U.S. Cl. CPC F16B 1/00
USPC 403/376

(57) ABSTRACT

An engaging fixing module including a carrying main body, a shell surface, a placement adjusting component, and an engaging element is provided. The carrying main body includes a carrying surface and a first protruding column. The shell surface is assembled on the carrying main body and includes a second protruding column. The placement adjusting component is disposed on the carrying surface. The engaging element is disposed on the placement adjusting component, and includes a resist structure and moves relative to the carrying surface when an external magnetic force is applied on the placement adjusting component. When the engaging element moves away from the carrying surface, the second protruding column resists the resist structure. When the engaging element moves towards the carrying surface so that the resist structure is aligned to the first protruding column, the shell surface is slidable relative to the carrying surface.

This application claims the benefit of Taiwan application Serial No. 101138272, filed Oct. 17, 2012, the subject matter of which is incorporated herein by reference.

### BACKGROUND OF THE INVENTION

1. Field of the Invention

The invention relates in general to an engaging fixing module, and more particularly to an engaging fixing module with simplified mechanical structure capable of quickly completing the assembly and disassembly process between two objects.

2. Description of the Related Art

Latch elements, such as screws, bolts with thread structure, and nuts, provide great convenience and practicality to people's life. The latching function of the latch elements enables detachable and fixed assembly between objects. On the other hand, the design of latch element with thread structure mainly uses a tool such as a screw driver for the purpose of assembly and disassembly. The shape of the screw driver corresponds to that of the latch element.

During the manufacturing process of associated products or devices, the assembly operation of objects requires the use of many latch elements (such as screws). Consequently, applications such as assembly and disassembly occurring in the manufacturing process or testing process are time consuming, and incur additional cost. Therefore, how to provide a fixing device capable of disassembling or assembling objects and at the same time resolving the shortcomings of being time and labor consuming has become a prominent task for the industries.

For instance, the battery cover of the remote controller of an ordinary TV or associated AV device normally has an elastic or flexible engaging structure. When the user applies a force on the engaging structure of the battery cover to generate a deformation, the battery cover can be removed from or assembled onto the remove controller for replacing the battery conveniently. The design of such engaging structure effectively replaces the latch element with thread structure. However, the engaging structure causes risks to the appearance of the device, and may even end up with poor fixity due to the collision and loosening of the elements.

Many improvement technologies have been provided to resolve the above mentioned problems. Elements such as buckles, trails, slots or springs can also be used in the design of corresponding structures. For example, an electronic device, whose housing is equipped with automatic bouncing function, is disclosed in Taiwanese Patent Publication No. 1366379 “Electronic Device with Housing Assembly”.

To make the disassembly and assembly process more convenient and stable, most of the generally known improvement technologies provide an engaging structure with even more complicated design. The engaging structure with complicated design increases manufacturing cost and can hardly gain ideal application in related industries or technology fields.

### SUMMARY OF THE INVENTION

The invention is directed to an engaging fixing module mainly used in a device or an appliance having two objects capable of being assembled onto or disassembled from each other. Moreover, for the two objects to be assembled to or disassembled from each other, one object must be slidable relative to the other object in a direction parallel to the plane of the other object. The engaging fixing module of the present invention is based on a simple mechanical structure of the two objects, not only effectively decreasing the manufacturing cost but also providing an intuitive, fast and convenient operation of assembly and disassembly for resolving the shortcomings of being time and labor consuming occurring to the generally known latch element.

According to one embodiment of the present invention, an engaging fixing module including a carrying main body, a shell surface, a placement adjusting component, and an engaging element is provided. The carrying main body includes a carrying surface and a first protruding column. The shell surface is assembled on the carrying main body and includes a second protruding column. The placement adjusting component is disposed on the carrying surface. The engaging element is disposed on the placement adjusting component, and includes a resist structure and moves relative to the carrying surface in a direction perpendicular to the carrying surface when an external magnetic force is applied on the placement adjusting component. When the engaging element moves away from the carrying surface so that the resist structure is higher than the first protruding column relative to the carrying surface, the second protruding column resists the resist structure. When the engaging element moves towards the carrying surface so that the resist structure is aligned to the first protruding column relative to the carrying surface, the shell surface is slidable relative to the carrying surface.

According to another embodiment of the present invention, an engaging fixing module including a carrying main body, a shell surface, an elastic unit, a rotation assembly, and a magnet unit is provided. The carrying main body includes a carrying surface and a first protruding column. The shell surface is assembled on the carrying main body and includes a second protruding column. The elastic unit is disposed on the carrying surface. The rotation assembly includes a fulcrum and a crossbar unit, wherein the rotation assembly is disposed on the carrying surface through the fulcrum, and the elastic unit abutted against a first terminal portion of the crossbar unit. The magnet unit is disposed on a second terminal portion of the crossbar unit. The fulcrum is disposed between the first terminal portion and the second terminal portion. The second terminal portion rotates relative to the carrying surface because the magnet unit is forced by an external magnetic force. When the first terminal portion rotates away from the carrying surface and is higher than the first protruding column relative to the carrying surface, the first terminal portion resists the second protruding column so that the shell surface is fixed onto the carrying main body. When the first terminal portion rotates towards the carrying surface and is aligned to the first protruding column relative to the carrying surface, the shell surface is slidable relative to the carrying surface.

According to an alternate embodiment of the present invention, an engaging fixing module including a carrying main body, a shell surface, an elastic unit, a rotation assembly, and a paramagnetic material is provided. The carrying main body includes a carrying surface and a first protruding column. The shell surface is assembled on the carrying main body and includes a second protruding column. The elastic unit is disposed on the carrying surface. The rotation assembly includes a fulcrum and a crossbar unit, wherein the rotation assembly is disposed on the carrying surface through the fulcrum, and the elastic unit abutted against a first terminal portion of the crossbar unit. The paramagnetic material is disposed on a second terminal portion of the crossbar unit. The fulcrum is disposed between the first terminal portion and the second terminal portion. The second terminal portion rotates relative to the carrying surface because the paramagnetic material is forced by an external magnetic force. When the first terminal portion rotates away from the carrying surface and is higher than the first protruding column relative to the carrying surface, the first terminal portion resists the second protruding column so that the shell surface is fixed onto the carrying main body. When the first terminal portion rotates towards the carrying surface and is aligned to the first protruding column relative to the carrying surface, the shell surface is slidable relative to the carrying surface.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a cross-sectional view showing an engaging fixing module 100 of the present invention having completed the assembly process;

FIGS. 2 (a) to (c) are operation diagrams showing a shell surface 10 of an engaging fixing module 100 being assembled to a carrying main body 20;

FIGS. 3 (a) to (c) are operation diagrams showing a shell surface 10 of an engaging fixing module 100 being disassembled from a carrying main body 20;

FIGS. 4 (a) to (c) are operation diagrams showing a shell surface 10 of an engaging fixing module 102 being assembled to a carrying main body 20;

FIGS. 5 (a) to (c) are operation diagrams showing a shell surface 10 of an engaging fixing module 102 being disassembled from a carrying main body 20;

FIGS. 6 (a) to (c) are operation diagrams showing a shell surface 10 of an engaging fixing module 103 being disassembled from a carrying main body 20;

FIGS. 7 (a) to (c) are operation diagrams showing a shell surface 10 of an engaging fixing module 104 being assembled to a carrying main body 20;

FIGS. 8 (a) to (c) are operation diagrams showing a shell surface 10 of an engaging fixing module 104 being disassembled from a carrying main body 20.

### DETAILED DESCRIPTION OF THE INVENTION

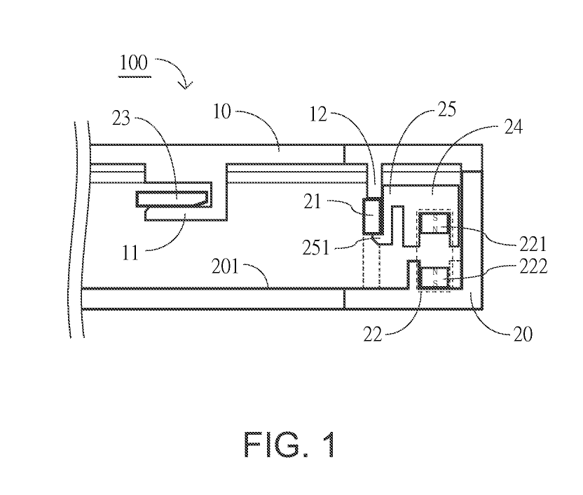

The present invention is exemplified by a first embodiment below. FIG. 1 is a cross-sectional view showing an engaging fixing module 100 of the present invention having completed the assembly process. As indicated in FIG. 1, the engaging fixing module 100 mainly includes two objects that can be assembled to each other. The two objects are such as a shell surface 10 and a carrying main body 20. The shell surface 10 is assembled on the carrying main body 20 in a detachable manner. The carrying main body 20 includes a carrying surface 201, a first protruding column 21 and a third protruding column 23. The shell surface 10 includes a second protruding column 12 and a hooking structure 11. The engaging fixing module 100 further includes a placement adjusting component 22 and an engaging element 24. The placement adjusting component 22 is partly disposed on the carrying surface 201. The engaging element 24 is disposed on the placement adjusting component 22. In addition, the engaging element 24 includes a resist structure 25.

In the present embodiment, the engaging element 24 has a squared appearance. The placement adjusting component 22 is disposed on the carrying surface 201 and composed of a first magnet unit 221 and a second magnet unit 222. The first magnet unit 221 is disposed in corresponding recess of the engaging element 24. The second magnet unit 222 is disposed on the carrying surface 201 and opposite to the first magnet unit 221. That is, the first magnet unit 221 and the second magnet unit 222 are adjacent to each other by the terminals of the same magnetic polarity such as the N-polarity as shown in FIG. 1. As indicated in FIG. 1, due to a magnetic repulsion between the first magnet unit 221 and the second magnet unit 222, the engaging element 24 is disposed opposite to the carrying surface 201 or is located at a first position.

On the other hand, the resist structure 25 is formed on one side of the engaging element 24. The bottom of the resist structure 25 has a protruded terminal portion 251, so that when the engaging element 24 is located at the first position due to the magnetic repulsion, the first protruding column 21 can stop the resist structure 25. That is, the first protruding column 21 can stop the resist structure 25 and the engaging element 24 protruding further. In other implementations, it can be designed in a manner that the magnetic repulsion makes the engaging element 24 suspended and exactly located at the first position.

When receiving an external mechanical force, the engaging element 24 moves downwards and approaches the carrying surface 201 in a direction perpendicular to the carrying surface 201. Besides, when receiving an external magnetic force, the placement adjusting component 22 composed of the first magnet unit 221 and the second magnet unit 222 also enables the engaging element 24 to move downwards and approaches the carrying surface 201 in a direction perpendicular to the carrying surface 201. On the other hand, when receiving an external force, the first magnet unit 221 and the second magnet unit 222 correspondingly get closer to each other and accordingly increase the magnetic repulsion between the first magnet unit 221 and the second magnet unit 222. After the external force is released, the engaging element 24 moves upwards and away from the carrying surface 201 in a direction perpendicular to the carrying surface 201. That is, the engaging element 24 is restored in response to the increased magnetic repulsion between the first magnet unit 221 and the second magnet unit 222.

In the present embodiment, the first magnet unit 221 and the second magnet unit 222 are fixedly disposed in corresponding recess of the engaging element 24 and on the carrying surface 201 respectively. In other implementations, the first magnet unit 221 merely enables the engaging element 24 to be suspended thereon and does not have to be fixedly disposed in the recess of the engaging element 24. Therefore, when the external magnetic force makes the first magnet unit 221 and the second magnet unit 222 move towards each other, the engaging element 24 will correspondingly fall down in a direction perpendicular to the carrying surface 201.

Details of the assembly and disassembly operations of the engaging fixing module 100 of the present invention are disclosed below.

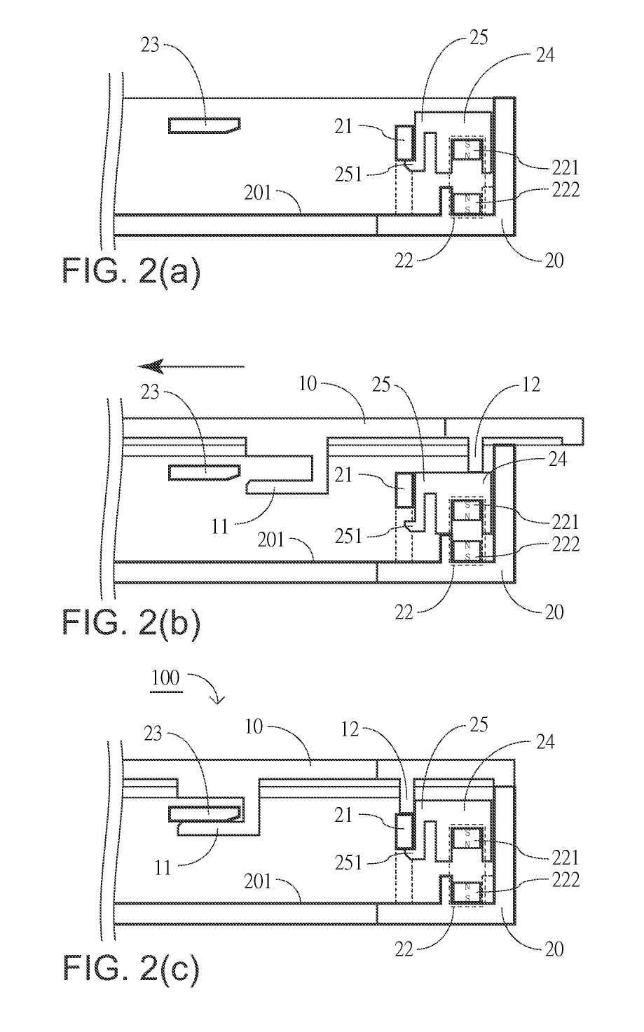

FIGS. 2 (a) to (c) are operation diagrams showing a shell surface 10 of an engaging fixing module 100 being assembled to a carrying main body 20. As indicated in FIG. 2 (a), the shell surface 10 is not yet assembled on the carrying main body 20. In the current state, the engaging element 24 is located at a first position as shown in FIG. 1. In the present embodiment, the first position is defined as the position at which the engaging element 24 is higher than the first protruding column 21. To put it in greater details, the top surface of the resist structure 25 is higher than the top surface of the first protruding column 21 in a direction perpendicular to the carrying surface 201.

As indicated in FIGS. 2 (b) and (c), the shell surface 10 is assembled to the carrying main body 20. The shell surface 10 of the present invention is assembled on the carrying main body 20 by sliding relative to the carrying surface 201 in a direction parallel to the carrying surface 201. The second protruding column 12 of the shell surface 10 pushes the engaging element 24, so that the engaging element 24 is located at a second position as shown in FIG. 2 (b). The shell surface 10 slides on the carrying main body 20 so that the third protruding column 23 is engaged with the hooking structure 11 to complete the fixing process. Therefore, the second protruding column 12 must push the engaging element 24 downwards to a predetermined position. The position at which the first protruding column 21 is disposed can be used as a reference point for the sliding of the shell surface 10.

Therefore, the second position is defined as the position at which the height of the engaging element 24 is the same as that of the first protruding column 21. To put it in greater details, the second position refers to the top surface of the resist structure 25 being aligned to the top surface of the first protruding column 21 in a direction perpendicular to the carrying surface 201. Being pushed by the second protruding column 12, the engaging element 24 can move towards the carrying surface 201 in a direction perpendicular to the carrying surface 201. On the other hand, the first magnet unit 221 and the second magnet unit 222 correspondingly approach to each other to increase the magnetic repulsion between the first magnet unit 221 and the second magnet unit 222. When the engaging element 24 is located at the second position, that is, when the resist structure 25 is aligned to the first protruding column 21, the shell surface 10 is slidable relative to the carrying surface 201 along an arrow direction as shown in FIG. 2 (b).

As indicated in FIG. 2 (c), when the shell surface 10 slides to a predetermined position so that the third protruding column 23 can be engaged with the hooking structure 11, the second protruding column 12 correspondingly moves away from the engaging element 24 to release the above pushing state and restore the increased magnetic repulsion between the first magnet unit 221 and the second magnet unit 222. Moreover, the engaging element 24 moves away from the carrying surface 201 so that the resist structure 25 is higher than the first protruding column 21 relative to the carrying surface 201, the second protruding column 12 can resist the resist structure 25 of the engaging element 24, and the shell surface 10 is fixedly assembled on the carrying main body 20.

In other words, the magnetic repulsion between the first magnet unit 221 and the second magnet unit 222 is restored so that the engaging element 24 is pushed back to the first position as shown in FIG. 2 (a), and the shell surface 10 is resisted by the resist structure 25 and will not slide or come off the carrying main body 20. FIG. 2 (c) is similar to FIG. 1. Given that associated elements have corresponding shapes and sizes, the engaging element 24 located at the first position will fix the shell surface 10 and the carrying main body 20 have been assembled to each other.

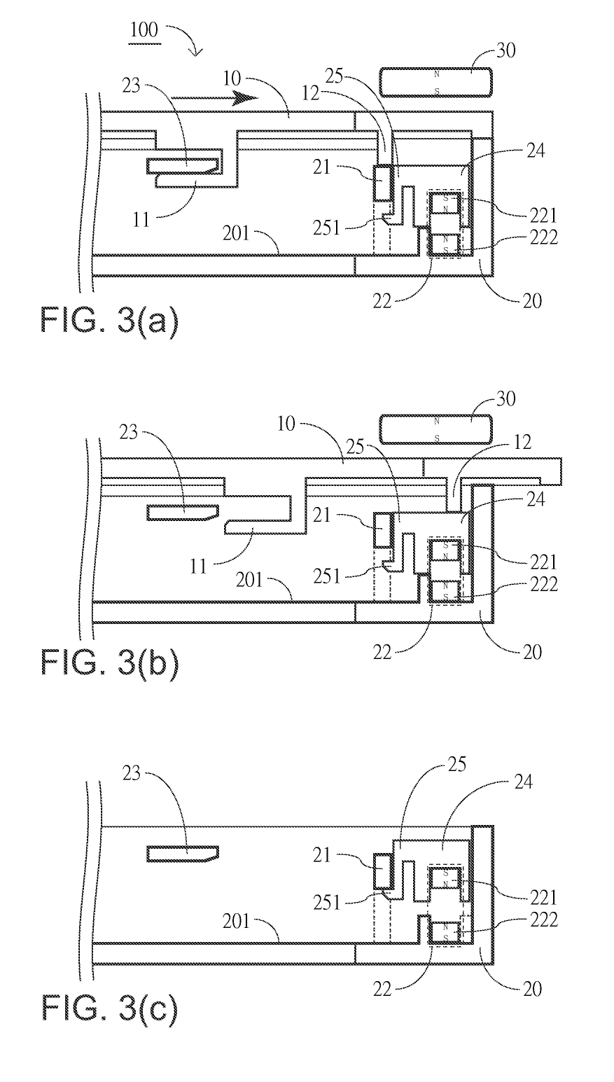

FIGS. 3 (a) to (c) are operation diagrams showing a shell surface 10 of an engaging fixing module 100 being disassembled from a carrying main body 20. In the present embodiment, the operation of disassembling the shell surface 10 from the carrying main body 20 is reverse to the assembly operation disclosed above. That is, the shell surface 10 of the present invention slides relative to the carrying surface 201 in a direction parallel to the carrying surface 201 so as to be disassembled from the carrying main body 20. As indicated in FIG. 3 (a), a magnet removing unit 30 (the S-polarity) is corresponding to the engaging element 24 and disposed adjacent to the shell surface 10 to increase the magnetic repulsion between the magnet removing unit 30 and the first magnet unit 221 underneath and accordingly increase the magnetic repulsion between the first magnet unit 221 and the second magnet unit 222.

As indicated in FIG. 3 (a), the magnet removing unit 30 is designed to have a sufficient magnetic force for overcoming the magnetic repulsion between the first magnet unit 221 and the second magnet unit 222, so that the first magnet unit 221 and the second magnet unit 222 can approach to each other for enabling the engaging element 24 to be located at the second position. To put it in greater details, the external magnetic force moves the engaging element 24 downwards to approach the carrying surface 201 in a direction perpendicular to the carrying surface 201, so that the resist structure 25 is aligned to the first protruding column 21 and the magnetic repulsion between the first magnet unit 221 and the second magnet unit 222 is increased accordingly. In other words, when the engaging element 24 is located at the second position, the resist structure 25 cannot resist the second protruding column 12, so that the shell surface 10 is slidable relative to the carrying surface 201 along an arrow direction as shown in FIG. 3 (a).

As indicated in FIG. 3 (b), the shell surface 10 slides to a position at which the third protruding column 23 is no more engaged with the hooking structure 11. Meanwhile, the second protruding column 12 is correspondingly moved to be on the engaging element 24. In the current state, the shell surface 10 is released and can be disassembled from the carrying main body 20. Lastly, the magnet removing unit 30 is removed, so that the external magnetic force is released and the increased magnetic repulsion between the first magnet unit 221 and the second magnet unit 222 can be restored. The current state is shown in FIG. 3 (c). In other words, the engaging element 24 is again pushed back to the first position. Like FIG. 2 (a), FIG. 3 (c) is again in a state capable of providing assembly.

In the present embodiment, the engaging fixing module 100 includes the magnet removing unit 30. In other implementations, the magnet removing unit 30 can be formed by other magnet having corresponding magnetic force.

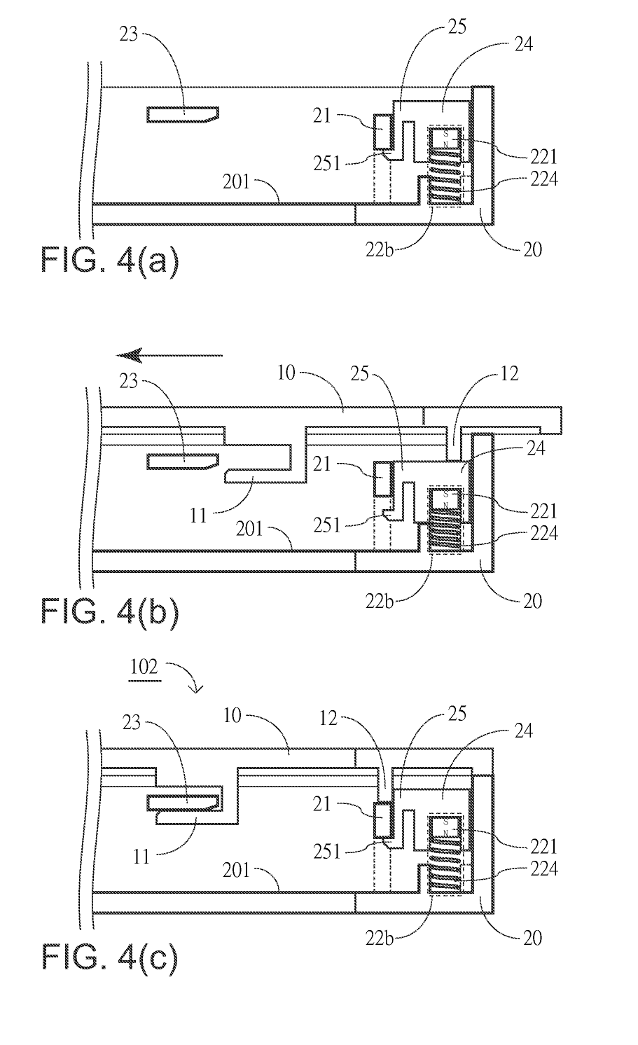

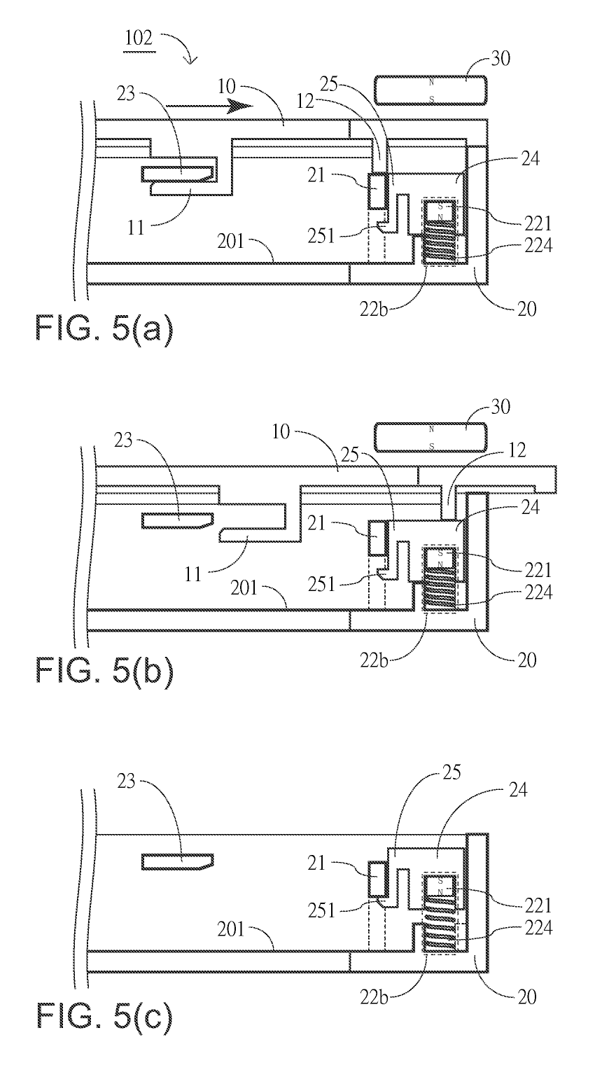

Based on the concepts of the first embodiment, the present invention can have various implementations, and can achieve equivalent effects with similar structural design. The present invention is exemplified by a second embodiment below. The present invention provides an engaging fixing module 102. Referring to FIGS. 4 (a) to (c) and FIGS. 5 (a) to (c) respectively. FIGS. 4 (a) to (c) are operation diagrams showing a shell surface 10 of an engaging fixing module 102 being assembled to a carrying main body 20. FIGS. 5 (a) to (c) are operation diagrams showing a shell surface 10 of an engaging fixing module 102 being disassembled from a carrying main body 20. FIG. 4 (c) is a cross-sectional view of an engaging fixing module 102 of the present embodiment having completed the assembly process.

The design of the second embodiment is similar to that of the first embodiment except that some variations are made to a placement adjusting component 22b. As indicated in FIG. 4 (a), the placement adjusting component 22b is composed of a first magnet unit 221 and an elastic unit 224. Similarly, the first magnet unit 221 is disposed in corresponding recess of the engaging element 24, the elastic unit 224 is disposed on the carrying surface 201 and adjacent to the first magnet unit 221, and the first magnet unit 221 is disposed on the elastic unit 224. In the present embodiment, the disposition of magnetic direction of the first magnet unit 221 is not restricted, and the elastic unit 224 can be realized by a spring or an elastic piece.

As indicated in FIGS. 4 (a) to (c), the assembly operation of the second embodiment is the same as that of the first embodiment. In the second embodiment, the engaging element 24, when pushed by the second protruding column 12, moves downwards and accordingly compresses the elastic unit 224 to generate a deformation, so that the shell surface 10 is slidable relative to the carrying surface 201 along an arrow direction as shown in FIG. 4 (b). When the shell surface 10 slides to a predetermined position so that the third protruding column 23 is engaged with the hooking structure 11 and the second protruding column 12 correspondingly leaves the engaging element 24, the elastic unit 224 restores deformation and pushes the engaging element 24 upwards. Consequently, the second protruding column 12 can resist the resist structure 25 and the shell surface 10 is fixedly assembled on the carrying main body 20.

It can be known from FIGS. 5 (a) to (c) that the disassembly operation of the second embodiment is the same as that of the first embodiment. In the second embodiment, when the magnet removing unit 30 (the S-polarity) is corresponding to the engaging element 24 and disposed adjacent to the shell surface 10 to increase the magnetic repulsion between the magnet removing unit 30 and the first magnet unit 221 underneath, the elastic unit 224 accordingly generates compressing deformation. The first magnet unit 221 further moves the engaging element 24 downwards so that the shell surface 10 is slidable relative to the carrying surface 201 along an arrow direction as shown in FIG. 5 (a). When the shell surface 10 slides to a position at which the third protruding column 23 is no more engaged with the hooking structure 11, the shell surface 10 is released and can be disassembled from the carrying main body 20.

In other words, the placement adjusting component 22b of the second embodiment adjusts the movement of the engaging element 24 on the carrying surface 201 with the elastic deformation of the elastic unit and the magnetic repulsion between the magnets.

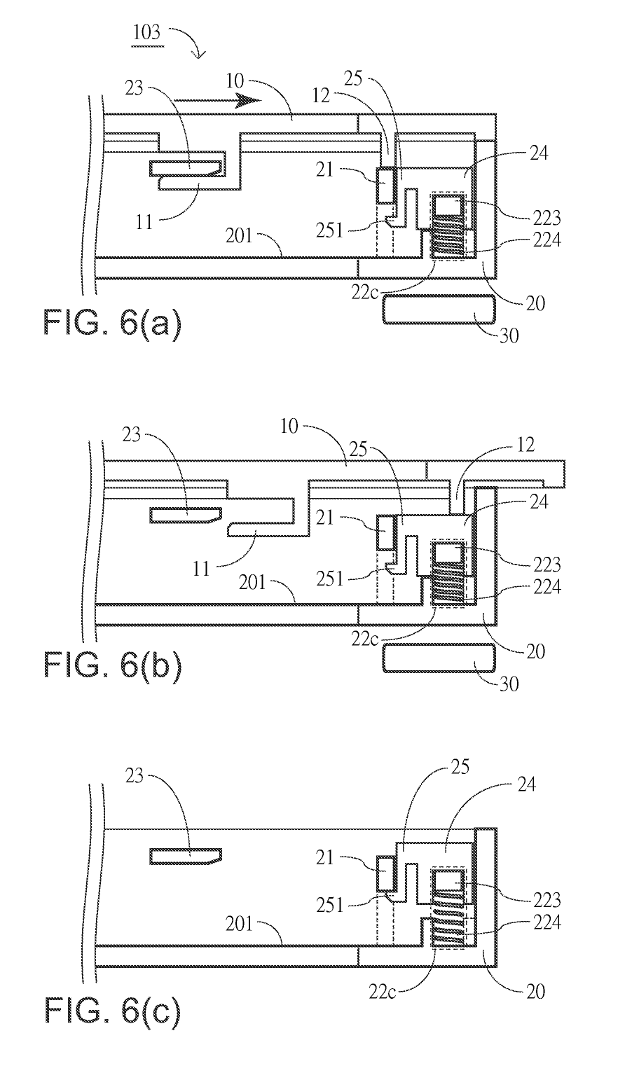

Similarly, variations can be made to the present invention based on the concepts of the first and the second embodiment. The present invention is further exemplified by a third embodiment. The present invention provides an engaging fixing module 103. FIGS. 6 (a) to (c) are operation diagrams showing a shell surface 10 of an engaging fixing module 103 being disassembled from a carrying main body 20. The assembly operation of the engaging fixing module 103 of the third embodiment is the same as that of the second embodiment, and the similarities are not repeated here. FIG. 6 (a) is a cross-sectional view of an engaging fixing module 103 of the present embodiment having completed the assembly process.

In the third embodiment, the first magnet unit 221 of the second embodiment is replaced with a paramagnetic material 223. That is, the placement adjusting component 22c is composed of a paramagnetic material 223 and an elastic unit 224. The paramagnetic material 223 is also disposed in corresponding recess of the engaging element 24. The elastic unit 224 is disposed on the carrying surface 201 and adjacent to the paramagnetic material 223, and the paramagnetic material 223 is also disposed on the elastic unit 224. To put it in greater details, the paramagnetic material 223 relates to a unit capable of generating a corresponding magnetic attraction as a magnet approaches, and can be formed by such as a metal.

The disassembly operation of the third embodiment is illustrated in FIGS. 6 (a) to (c). The magnet removing unit 30 whose corresponding magnetic direction is not restricted, is corresponding to the engaging element 24 and disposed adjacent to the carrying main body 20 to increase the magnetic attraction between the magnet removing unit 30 and the paramagnetic material 223 atop of the magnet removing unit 30. The elastic unit 224 is accordingly compressed to generate a deformation for moving the engaging element 24 downwards so that the shell surface 10 is slidable relative to the carrying surface 201 along an arrow direction as shown in FIG. 6 (a). When the shell surface 10 slides to a position at which the third protruding column 23 cannot be engaged with the hooking structure 11, the shell surface 10 is released and can be disassembled from the carrying main body 20.

In other words, the placement adjusting component 22c of the third embodiment adjusts the movement of the engaging element 24 on the carrying surface 201 with the elastic deformation of the elastic unit and the magnetic attraction between the paramagnetic material and the magnet.

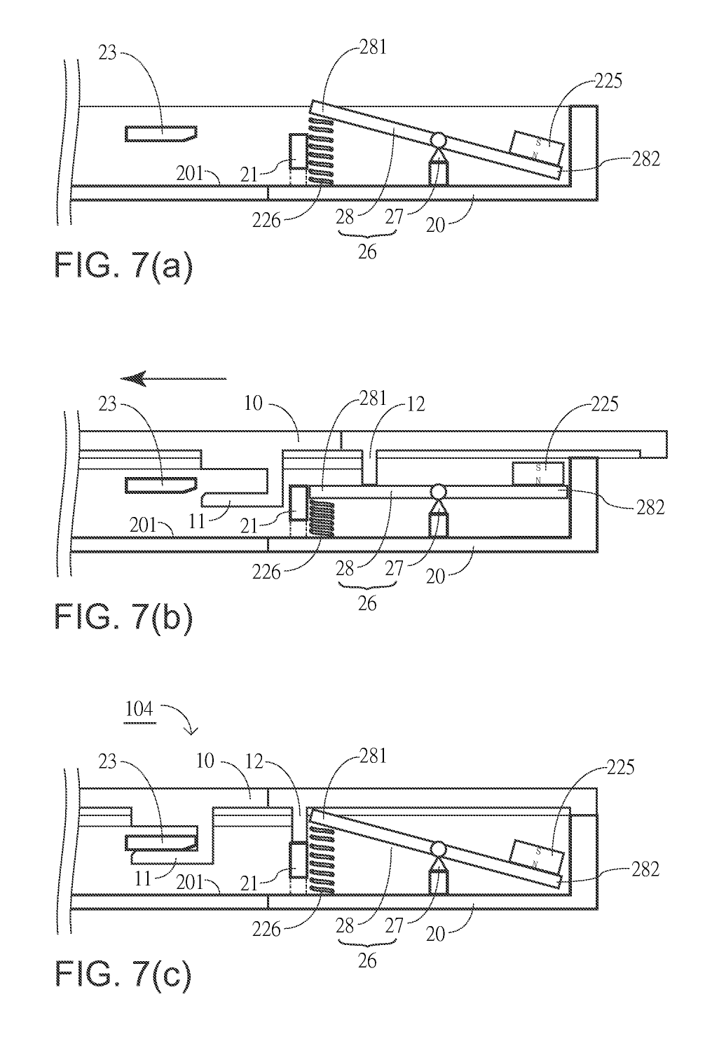

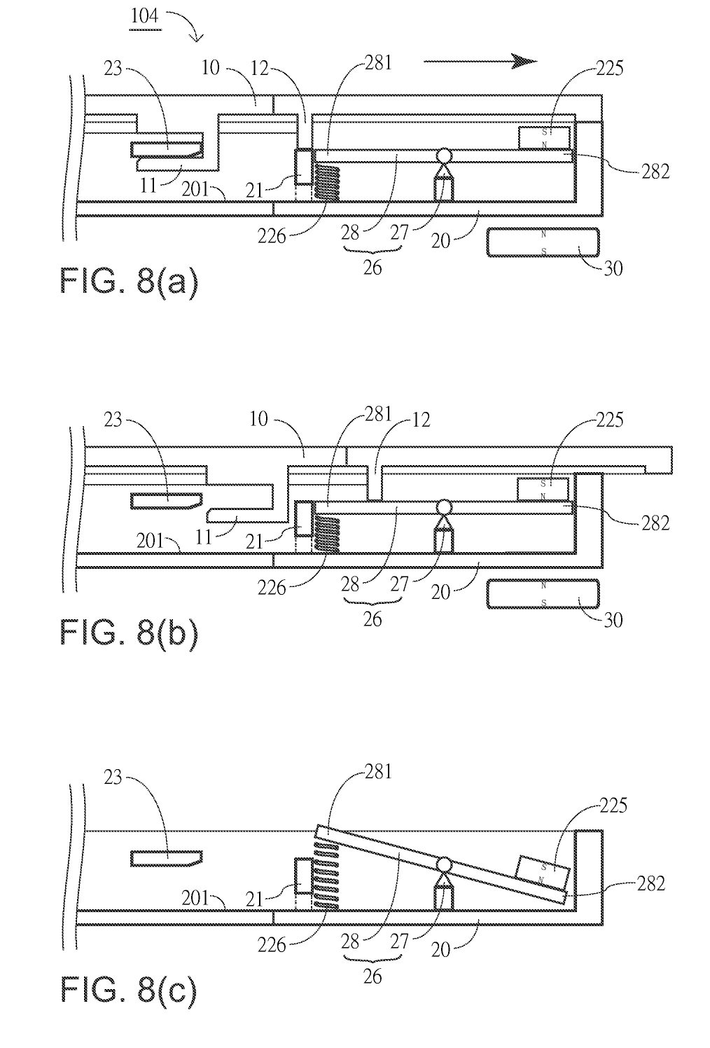

Similarly, variations can be made to the present invention based on the concepts of the above embodiments. The present invention is further exemplified by a fourth embodiment. The present invention provides an engaging fixing module 104. Referring to FIGS. 7 (a) to (c) and FIGS. 8 (a) to (c) respectively. FIGS. 7 (a) to (c) are operation diagrams showing a shell surface 10 of an engaging fixing module 104 being assembled to a carrying main body 20. FIGS. 8 (a) to (c) are operation diagrams showing a shell surface 10 of an engaging fixing module 104 being disassembled from a carrying main body 20. FIG. 7 (c) is a cross-sectional view of an engaging fixing module 104 of the present embodiment having completed the assembly process.

The fourth embodiment is featured by the design that a rotation assembly 26 of the engaging fixing module 104 collaborates with a magnet unit 225 and an elastic unit 226. As indicated in FIG. 7 (a), the rotation assembly 26 is composed of a fulcrum 27 and a crossbar unit 28. The rotation assembly 26 is disposed on the carrying surface 201 through the fulcrum 27. The elastic unit 226 abuts against a first terminal portion 281 of the crossbar unit 28, and the magnet unit 225 is disposed on a second terminal portion 282 of the crossbar unit 28. The fulcrum 27 is disposed between the first terminal portion 281 and the second terminal portion 282. In the present embodiment, the disposition of magnetic direction of the magnet unit 225 is not restricted.

It can be known from FIGS. 7 (a) to (c) that the assembly operation of the fourth embodiment is similar to that of the above embodiments. In the fourth embodiment, the second protruding column 12 pushes the first terminal portion 281 downwards so that the first terminal portion 281 rotate towards the carrying surface 201 and is aligned to the first protruding column 21 relative to the carrying surface 201, so that the shell surface 10 is slidable relative to the carrying surface 201, and accordingly compresses the elastic unit 226 to generate a deformation. When the shell surface 10 slides to a predetermined position at which the third protruding column 23 is engaged with the hooking structure 11 and the second protruding column 12 correspondingly leaves the first terminal portion 281, the elastic unit 226 restores deformation and enables the first terminal portion 281 to rotate away from the carrying surface 201. Moreover, when the first terminal portion 281 is higher than the first protruding column 21 relative to the carrying surface 201, the second protruding column 12 resists the first terminal portion 281, and the shell surface 10 can be fixedly assembled on the carrying main body 20.

The disassembly operation of the fourth embodiment is shown in FIGS. 8 (a) to (c). The magnet removing unit 30 (the N-polarity) is corresponding to the second terminal portion 282 and disposed adjacent to the carrying main body 20 to increase the magnetic repulsion between the magnet removing unit 30 and the magnet unit 225, so that the first terminal portion 281 rotates towards the carrying surface 201 and is aligned to the first protruding column 21 relative to the carrying surface 201. The first terminal portion 281 accordingly compresses the elastic unit 226 to generate a deformation, so that the shell surface 10 is slidable relative to the carrying surface 201 along an arrow direction as shown in FIG. 8 (a). When the shell surface 10 slides to a position at which the third protruding column 23 is no more engaged with the hooking structure 11, the shell surface 10 is released and can be disassembled from the carrying main body 20.

In other words, given that the magnet unit 225 and the elastic unit 226 are separated from each other, the movement of some associated parts capable of generating the resistive effects can be adjusted on the carrying surface 201 based on the design of the rotation assembly 26 of the fourth embodiment.

The fourth embodiment can have various implementations. For instance, the magnet unit 225 of the fourth embodiment is replaced with a paramagnetic material. As disclosed in the third embodiment, the paramagnetic material can generate corresponding magnetic attraction as the magnet approaches. According to the corresponding disassembly operation, the magnet removing unit 30 is disposed adjacent to the shell surface 10 to increase the magnetic attraction between the magnet removing unit 30 and the paramagnetic material for enabling the first terminal portion 281 to rotate towards the carrying surface 201 so that the shell surface 10 is slidable relative to the carrying surface 201 and can be disassembled. Details of the operation can be known from the disclosure of the above embodiments, and the similarities are not repeated here.

It can be known from the disclosure of the above embodiments that the engaging fixing module of the present invention is mainly used in a device or an appliance having two objects capable of being assembled onto or disassembled from each other. Furthermore, the assembly or disassembly of the two objects requires one object sliding relative to the other object in a direction parallel to the object. For instance, the engaging fixing module of the present invention can be effectively used in portable electronic devices, such as mobile phones, personal digital assistants, and tablets. The engaging fixing module of the present invention can be effectively used in other electronic devices or mechanical appliances having two elements, which are similar to the shell surface and the carrying main body of the present invention and capable of assembled or disassembled by sliding relative to each other.

To summarize, the engaging fixing module of the present invention can assemble two objects with a simple mechanical structure to effectively reduce the manufacturing cost. Also, the assembly and disassembly operations are intuitive, convenient and fast, and resolve the shortcomings of being time and labor consuming occurring to the generally known latch element. Meanwhile, during the manufacturing process, the shapes and sizes of the elements of the present invention are optimized, so that the stability in assembly operation is effectively increased, and the present invention can thus become an ideal application in the industries or related technology fields. Therefore, the present invention effectively resolves the problems disclosed in the prior art, and successfully achieve the desired purpose.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An engaging fixing module, comprising:
a carrying main body, comprising a carrying surface and a first protruding column;
a shell surface assembled on the carrying main body, wherein the shell surface comprises a second protruding column;
a placement adjusting component disposed on the carrying surface; and
an engaging element disposed on the placement adjusting component, wherein the engaging element moves relative to the carrying surface in a direction perpendicular to the carrying surface when an external magnetic force is applied on the placement adjusting component, and the engaging element comprises a resist structure;
wherein, when the engaging element moves away from the carrying surface so that the resist structure is higher than the first protruding column relative to the carrying surface, the second protruding column of the shell surface resists the resist structure, and when the engaging element moves towards the carrying surface so that the resist structure is aligned to the first protruding column relative to the carrying surface, the shell surface is slidable relative to the carrying surface.

2. The engaging fixing module according to claim 1, wherein the carrying main body comprises a third protruding column, the shell surface comprises a hooking structure, and when the third protruding column is engaged with the hooking structure, the shell surface is fixed onto the carrying main body.

3. The engaging fixing module according to claim 1, wherein the placement adjusting component comprises:
a first magnet unit disposed on the engaging element; and
a second magnet unit disposed on the carrying surface and opposite to the first magnet unit;
wherein, the first magnet unit and the second magnet unit are adjacent to each other by the same magnetic polarity.

4. The engaging fixing module according to claim 3, wherein the engaging fixing module comprises a magnet removing unit corresponding to the engaging element and disposed adjacent to the shell surface to increase a magnetic repulsion between the first magnet unit and the second magnet unit.

5. The engaging fixing module according to claim 1, wherein the placement adjusting component comprises:
a first magnet unit disposed on the engaging element; and
an elastic unit disposed on the carrying surface and adjacent to the first magnet unit.

6. The engaging fixing module according to claim 1, wherein the placement adjusting component comprises:
a paramagnetic material disposed on the engaging element; and
an elastic unit disposed on the carrying surface and adjacent to the paramagnetic material.

7. The engaging fixing module according to claim 5, wherein the engaging fixing module comprises a magnet removing unit corresponding to the engaging element and disposed adjacent to the shell surface to increase a magnetic repulsion between the magnet removing unit and the first magnet unit and accordingly compress the elastic unit.

8. The engaging fixing module according to claim 6, wherein the engaging fixing module comprises a magnet removing unit corresponding to the engaging element and disposed adjacent to the carrying main body to increase a magnetic attraction between the magnet removing unit and the paramagnetic material and accordingly compress the elastic unit.

9. The engaging fixing module according to claim 1, wherein the resist structure comprises a protruded terminal portion resisting the first protruding column.

10. An engaging fixing module, comprising:
a carrying main body, comprising a carrying surface and a first protruding column;
a shell surface assembled on the carrying main body, wherein the shell surface comprises a second protruding column;
an elastic unit disposed on the carrying surface;
a rotation assembly, comprising a fulcrum and a crossbar unit, wherein the rotation assembly is disposed on the carrying surface through the fulcrum, and the elastic unit abutted against a first terminal portion of the crossbar unit; and
a magnet unit disposed on a second terminal portion of the crossbar unit, wherein the fulcrum is disposed between the first terminal portion and the second terminal portion;
wherein, the second terminal portion rotates relative to the carrying surface because the magnet unit is forced by an external magnetic force, and when the first terminal portion rotates away from the carrying surface and is higher than the first protruding column relative to the carrying surface, the first terminal portion resists the second protruding column so that the shell surface is fixed onto the carrying main body, and when the first terminal portion rotates towards the carrying surface and is aligned to the first protruding column relative to the carrying surface, the shell surface is slidable relative to the carrying surface.

11. The engaging fixing module according to claim 10, wherein during the assembly process, the second protruding column pushes the first terminal portion for rotating the first terminal portion towards the carrying surface, so that the first terminal portion is aligned to the first protruding column relative to the carrying surface and compresses the elastic unit.

12. The engaging fixing module according to claim 10, wherein the engaging fixing module comprises a magnet removing unit corresponding to the second terminal portion and disposed adjacent to the carrying main body to increase a magnetic repulsion between the magnet removing unit and the magnet unit and accordingly compress the elastic unit.

13. An engaging fixing module, comprising:
a carrying main body, comprising a carrying surface and a first protruding column;
a shell surface assembled on the carrying main body, wherein the shell surface comprises a second protruding column;
an elastic unit disposed on the carrying surface;
a rotation assembly, comprising a fulcrum and a crossbar unit, wherein the rotation assembly is disposed on the carrying surface through the fulcrum, and the elastic unit abutted against a first terminal portion of the crossbar unit; and
a paramagnetic material disposed on a second terminal portion of the crossbar unit, wherein the fulcrum is disposed between the first terminal portion and the second terminal portion;
wherein, the second terminal portion rotates relative to the carrying surface because the paramagnetic material is forced by an external magnetic force, and when the first terminal portion rotates away from the carrying surface and is higher than the first protruding column relative to the carrying surface, the first terminal portion resists the second protruding column so that the shell surface is fixed onto the carrying main body, and when the first terminal portion rotates towards the carrying surface and is aligned to the first protruding column relative to the carrying surface, the shell surface is slidable relative to the carrying surface.

14. The engaging fixing module according to claim 13, wherein the engaging fixing module comprises a magnet removing unit corresponding to the second terminal portion and disposed adjacent to the shell surface to increase a magnetic attraction between the magnet removing unit and the paramagnetic material and accordingly compress the elastic unit.
